(19) United States
(12) Patent Application Publication
(10) Pub. No.: US 2009/0104107 A1
(43) Pub. Date: Apr. 23, 2009

(54) Methods of making and washing scorodite

(75) Inventors: Yukio Kimura, Hitachi-shi (JP); Shigeo Katsura, Hitachi-shi (JP)

Correspondence Address: BIRCH STEWART KOLASCH & BIRCH, PO BOX 747, FALLS CHURCH, VA, 22040-0747, US

(73) Assignee: NIPPON MINING & METALS CO., LTD., Tokyo (JP)

(21) Appl. No.: 12/155,468

(22) Filed: Jun. 4, 2008

(30) Foreign Application Priority Data
Oct. 23, 2007 (JP) 2007-275070

(51) Int. Cl. C01G 49/02; B08B 7/04

(52) U.S. Cl. 423/594.1; 134/18

(57) ABSTRACT

A method of making scorodite includes the following steps: (1) an acidic aqueous solution containing pentavalent As and trivalent Fe is heated at a temperature for a time, the temperature and the time being effective for synthesis of crystalline scorodite; (2) the synthesized scorodite is separated from the post-reaction solution by solid-liquid separation; and (3) the scorodite is washed with water and is separated from the washing solution by solid-liquid separation. Step (3) is repeated until the concentration of at least one component of the post-reaction solution contained in the washing solution used for washing the scorodite decreases to a predetermined level.

### BACKGROUND OF THE INVENTION

1. Field of the Invention

The present invention relates to a method of making scorodite. In-particular, the present invention relates to a method of making scorodite from electrolytically precipitated copper that is yielded in a copper refining process. The present invention also relates to a method of washing scorodite from which leaching of arsenic is reduced.

2. Related Art

Copper ore contains a variety of impurities such as arsenic (As). Arsenic (As) is separated by volatilization at high temperatures during a dry process for copper refining, but partly remains in crude copper before electrolytic refining.

As contained in the crude copper (copper anode) is partly eluted in an electrolytic solution, while the uneluted As is contained in the anode slime that is precipitated on the bottom of the electrolytic bath. Since the copper volume deposited on the cathode is generally larger than that eluted from the anode, the copper content in the electrolytic solution gradually increases. Part of the electrolytic solution is thus transferred to another electrolytic bath to control the quality of the electrolytic solution. The transferred electrolytic solution is subjected to decoppering electrolysis. Impurities such as Cu and As are deposited on the cathode and precipitated on the bottom of the electrolytic bath, which can be recovered. The precipitate on the bottom of the electrolytic bath and the deposition on the cathode are collectively referred to as electrolytically precipitated copper in the art.

In general, the electrolytically precipitated copper is recycled to the copper refining process. It is therefore preferred to separate impurities such as arsenic from the electrolytically precipitated copper preliminarily. Furthermore, As can be utilized as a valuable resource. Accordingly, a process for recovering high-quality As from the electrolytically precipitated copper. The recovered arsenic is desirably converted in the form of a stable compound in order to prevent environmental pollution.

It is known that the formation of crystalline scorodite (FeAsO₄.2H₂O), which is a iron-arsenic compound, is effective for stabilization of arsenic. The crystalline scorodite is chemically stable and suitable for long-term preservation. In contrast, amorphous scorodite is instable and is not suitable for long-term preservation.

For example, Japanese Patent No. 3756687 discloses a method of removing and stabilizing arsenide from an arsenic-containing solution that contains nonferrous metal components including copper and/or zinc and arsenic. The method includes a first step of reaction of the arsenic-containing solution with an iron(II) solution and/or an iron (III) solution at 120° C. or more to form stable crystalline scorodite as an iron-arsenic compound, and recovery of the scorodite containing the nonferrous metal components including copper from the arsenic-containing solution by solid-liquid separation; and a second step of repulping the scorodite (containing the nonferrous metal components including copper) prepared in the first step with water, and separating the nonferrous metal components including copper from the scorodite by leaching, whereby arsenic can be removed and fixed as stable crystalline scorodite without loss of valuable metals such as copper.

### SUMMARY OF THE INVENTION

On the method of preparing the stable scorodite, Japanese Patent No. 3756687 also discloses that “an Fe/As molar ratio less than 1.5 or higher than 2.0 leads to a significant decrease in crystallinity of the produced iron-arsenic compound and thus promotes elution of arsenic” and “a temperature less than 150° C. inhibits formation of the crystalline iron-arsenic compound, and arsenic is readily eluted from the resulting amorphous compound.”

On the significance of the second step subsequent to the first step for synthesis of the scorodite, the following description is found: “Scorodite contains copper and zinc in the form of sulfate. For example, about 10% of the overall copper is lost, if it is not recovered. Although arsenic is not eluted in this state, copper, as a valuable metal, is contained in the deposition. Thus, copper is recovered by separation from the scorodite in the second step.”

Accordingly, Japanese Patent No. 3756687 teaches that the Fe/As molar ratio and the control of the temperature in the reaction stage are critical for prevention of elution of arsenic from the scorodite.

However, according to the experimental results by The inventors of the present invention, arsenic in a variable concentration exceeding an environmental standard is eluted from the resulting scorodite in some cases, even if the synthetic conditions of the scorodite are optimized. A variation in quality of scorodite is not desirable. Accordingly, the present invention is directed to provide a method of stably making scorodite from which arsenic is barely eluted.

A possible factor of dissolution of arsenic from scorodite is the presence of amorphous scorodite. The amorphous scorodite exhibits low stability, and amorphous scorodite contained in crystalline scorodite causes arsenic to be eluted. Thus, it is believed that low stability of the resulting scorodite primarily results from incorporation of amorphous scorodite. The conventional technology to improve the stability of the scorodite has therefore been focused on formation of crystalline scorodite at high selectivity ratio in the synthetic process.

The inventors, however, have found that the quantity of eluted arsenic and its variation significantly depend on the washing operation after the synthesis of scorodite, as a result of study on arsenic elution from scorodite. It has been believed that the washing operation, which washes off the post-reaction solution, is effective for enhancement of quality of scorodite, and common operations such as solid-liquid separation and water washing have been employed. For example, the method of washing the scorodite carried out by the inventors is to repeat washing scorodite on a Buchner funnel by pouring water on the scorodite until blue color of copper ions disappears from the washing solution.

In the conventional knowledge, the stability of the scorodite primarily depends on the crystallinity of the synthesized scorodite. Elution of arsenic cannot be avoided in the case of low crystallinity of scorodite itself, even if the washing operation to remove the post-reaction solution remaining on the scorodite is sufficiently carried out. Accordingly, it has been believed that arsenic eluted after washing results from low crystallinity of the scorodite.

However, it has surprisingly proven that elution of arsenic from the scorodite is attributed to insufficient washing. It has also proven that as the component of the post-reaction solution contained in the washing solution decreases, the eluted value of the metal ions such as arsenic by the elution test of the scorodite decreases. Accordingly, the inventors discovered that monitoring of component of the post-reaction solution contained in the washing solution, for example, metal ion concentrations such as copper and arsenic in a washing operation to separate the post-reaction solution from the scorodite leads to ready formation of scorodite that has a desired elution level with a low variation.

An aspect of the present invention that has bee accomplished on the basis of the finding described above is a method of making scorodite comprising the steps of:

(1) heating an acidic aqueous solution containing pentavalent As and trivalent Fe at a temperature and for a time that are effective for synthesis of crystalline scorodite;

(2) separating the synthesized scorodite from the post-reaction solution by solid-liquid separation; and

(3) washing the scorodite with water and separating the scorodite from the washing solution by solid-liquid separation;

wherein step (3) is repeated until the concentration of at least one component of the post-reaction solution contained in the washing solution used for washing the scorodite decreases to a predetermined level.

In one embodiment of the method according to the present invention, step (3) is repeated until the concentration of As ion contained in the washing solution used for washing the scorodite decreases to a predetermined level.

In another embodiment of the method according to the present invention, step (3) is repeated until the concentration of As ion contained in the washing solution used for washing the scorodite decreases to 0.3 mg/L or less.

In another embodiment of the method according to the present invention, the acidic aqueous solution in step (1) is a sulfuric acid leaching solution of electrolytically precipitated copper, and step (3) is repeated until the concentration of at least one component of the post-reaction solution selected from the group consisting of Cu, S, Fe, and As contained in the washing solution used for washing the scorodite decreases to a predetermined level.

In another embodiment of the method according to the present invention, the acidic aqueous solution in step (1) is a sulfuric acid leaching solution of electrolytically precipitated copper, and step (3) is repeated until the concentration of Cu ion contained in the washing solution used for washing the scorodite decreases to a predetermined level.

In another embodiment of the method according to the present invention, the acidic aqueous solution in step (1) is a sulfuric acid leaching solution of electrolytically precipitated copper, the concentrations of Cu ion and As ion contained in the washing solution used for washing the scorodite after n-th (n≧1) step (3) are measured, a target concentration of the Cu ion is determined in response to the measured concentrations, and step (3) is repeated until the concentration of the Cu ion contained in the washing solution used for washing scorodite decreases to the target concentration.

In another embodiment of the method according to the present invention, the acidic aqueous solution in step (1) is a sulfuric acid leaching solution of electrolytically precipitated copper, the concentration of As ion is in the range of 0.1 to 3 g/L and the concentration of Cu ion is in the range of 10 to 60 g/L in the post-reaction solution, and the ratio of scorodite to water in each step (3) is such that 100 to 300 g (dry weight) of scorodite is washed with 1 L of water, and step (3) is repeated until the concentration of the Cu ion contained in the washing solution used for washing scorodite decreases to 10 mg/L or less.

In another embodiment of the method according to the present invention, whether the concentration of the Cu ion contained in the washing solution used for washing scorodite decreases to the predetermined level is determined by colorimetric analysis.

In another embodiment of the method according to the present invention, the washing in step (3) is performed by addition of water to the scorodite followed by repulping and agitation.

In another embodiment of the method according to the present invention, step (2) is carried out with spontaneous filtration using a funnel, and step (3) is carried out with gravimetric or suction filtration in which washing water is poured onto the scorodite placed on the funnel in such a manner that the entire scorodite is covered by the water while it is poured.

In another embodiment of the method according to the present invention, the scorodite is disposed in a vertical filter press, the water is supplied to the filter press, and then the scorodite is compressed.

Another aspect of the present invention is a method of washing scorodite comprising an operation of separating the scorodite from washing water by solid-liquid separation, wherein the concentration of at least one component of the post-reaction solution eluted from the scorodite contained in the washing solution used in the washing is measured, and whether the operation is repeated is determined in response to the measured concentration.

### EFFECT OF THE INVENTION

According to the present invention, scorodite exhibiting low arsenic elution can be produced constantly.

### BRIEF DESCRIPTION OF THE DRAWING

FIG. 1 shows transition of arsenic and copper concentrations in washing water in case where washing is carried out after preliminary washing of scorodite synthesized in Example 1.

### DESCRIPTION OF THE PREFERRED EMBODIMENTS

One of the subject matters according to the present invention is a method of making scorodite comprising the steps of:

(1) heating an acidic aqueous solution containing pentavalent As and trivalent Fe at a temperature and for a time that are effective for synthesis of crystalline scorodite;

(2) separating the synthesized scorodite from the post-reaction solution by solid-liquid separation; and

(3) washing the scorodite with water and separating the scorodite from the washing solution by solid-liquid separation;

wherein step (3) is repeated until the concentration of at least one component of the post-reaction solution contained in the washing solution used for washing the scorodite decreases to a predetermined level.

### Step (1)

In Step (1), scorodite is synthesized. The scorodite can be synthesized by heating an acidic aqueous solution containing pentavalent As and trivalent Fe at a temperature and for a time that are effective for synthesis of crystalline scorodite. Any condition known in the art suitable for synthesis of crystalline scorodite may be used in the present invention. Exemplary conditions are described below.

Pentavalent As is typically fed in the form of arsenic acid (H₃AsO₄), for example. Pentavalent As is typically present in the form of arsenic acid (H₃AsO₄) in the sulfuric acid leaching solution used for leaching electrolytically precipitated copper.

Trivalent Fe is typically fed in the form of iron oxide, iron sulfate, iron chloride, or iron hydroxide. Preferably, trivalent Fe is fed in the form of an acidic aqueous solution in view of the reaction in an aqueous solution, and in the form of an aqueous ferric sulfate (Fe₂(SO₄)₃) solution in view of recycling of the post-iron removal solution to an electrolytic solution for electrolytic refining, which is the most effective process. An aqueous polyferric sulfate solution, which is used in liquid waste treatment, can also be used.

The acidic aqueous solution may be typically an aqueous solution of hydrochloric acid, sulfuric acid, nitric acid, or perchloric acid. Typically, a sulfuric acid leaching solution after sulfuric acid leaching of electrolytically precipitated copper is used. Sulfuric acid leaching will be described later.

In order to enhance the reaction rate of As contained in the acidic aqueous solution, the amount of trivalent Fe is preferably 1.0 equivalent or more on the basis of pentavalent As, and more preferably 1.1 to 1.5 equivalent in economical view.

The pH of the acidic aqueous solution is preferably in the range of 1.0 to 1.5 for formation of crystalline scorodite.

The crystalline scorodite can be formed by heating the acidic solution to, for example, 60 to 95° C. under atmospheric pressure. A sufficient amount of crystalline scorodite can be formed through a reaction, for example, for 8 to 72 hours. Pentavalent As can react with trivalent iron with high reaction efficiency to form crystalline scorodite.

### Step (2)

In step (2), the synthesized scorodite is separated from the post-reaction solution by solid-liquid separation. This post-reaction solution contains ions of arsenic, copper, and other metals. Since these ions trapped in the scorodite are eluted during preservation, these must be sufficiently removed. Any known solid-liquid separation process can be used without limitation, and a typical process is filtration. Examples of filtration processes include gravimetric or spontaneous filtration, suction filtration, compression filtration, and centrifugal filtration. In general, gravimetric filtration is the lowest efficiency while compression filtration and centrifugal filtration are the highest efficiency. Suction filtration lies between them.

However, no solid-liquid separation process can achieve the target separation efficiency of the present invention, and additional washing is inevitable. In consideration of the subsequent washing with water, it is important to prevent cracking of scorodite cake prepared by filtration in the separation stage of the scorodite from the post-reaction solution. Cracks having small flow resistance in the cake lead to predominant flow of washing water, resulting in uneven washing.

It is preferred that suction filtration is not performed to avoid cracking. Gravimetric filtration (spontaneous filtration) is preferred. Although compression filtration may cause cracking, use of a vertical filter press (cake is vertically compressed) can suppress cracking. The vertical filter press can form cake having a uniform thickness regardless the volume of the cake. In a horizontal filter press (cake is horizontally compressed), slurry is supplied from the bottom of the chamber, whereby cake having a uniform thickness cannot be readily formed and cracking readily occurs by the effect of gravity, unlike the vertical filter press. As a result, the flow of washing water is concentrated to thin portions and cracks in the cake, resulting in uneven washing.

### Step (3)

Most of the post-reaction solution remaining in the scorodite is removed during Step (2). However, the elution of arsenic from the scorodite in this stage is not less than the standard in domestic repository sites in many cases, and the level of elution significantly varies in every product. Accordingly, in order to obtain scorodite with low elution properties constantly, the post-reaction solution should be completely separated from the scorodite by further washing with water.

In step (3), the washed scorodite is separated from the washing water by solid-liquid separation. Water washing removes water-soluble components, and the elution of arsenic from the scorodite gradually decreases by repeating the water washing, because most of the eluted arsenic is not derived from the scorodite itself but from the post-reaction solution remaining in the scorodite.

Since amorphous scorodite, which may be formed as a byproduct in the synthetic process of the scorodite, is highly soluble in water, it will be removed together with the post-reaction solution during the thorough washing operation. In fact, the washing operation removes not only the post-reaction solution but also the amorphous scorodite byproduct from the scorodite.

Any known washing method may be employed without restriction. It is preferred to determine the volume of the water used in one washing step and to reserve the washing solution used in each washing operation in order to clarify the number of the washing operations and to determine the concentration of each component of the post-reaction solution contained in the washing water. If water used in the washing is discarded, the number of the washing operations is not clear. Furthermore, in each washing operation, the concentration of the washing solution after washing the scorodite cannot be exactly determined because the concentration of each component in the post-reaction solution varies between the start and the end of the washing.

Effective Washing Processes are as Follows:

In a continuous treatment of washing and filtration with a funnel, a washing process that does not cause cracking on the scorodite cake is preferred, because cracking adversely affects the washing efficiency. In the filtration with a funnel, cracking does not occur when water is present on the cake, in other words, when the cake is completely immersed in the water. However, incomplete water supply causes the cake to be exposed on the water surface, resulting in cracking due to shrinkage of the cake. Accordingly, it is preferred that water is continually supplied to perform filtration such that the entire cake is covered by washing water (for example, the cake is completely immersed).

Another effective process is solid-liquid separation after agitating and repulping scorodite in a washing vessel. The concentration of each component of the post-reaction solution contained in the washing water may be determined by analyzing the washing water after the solid-liquid separation. Any solid-liquid separation process described in Step (2) can be employed without care for cracking.

A further preferred process is direct washing and filtration of cake comprising preparation of scorodite cake with a filter press, supply of washing water, and compression of the cake in the filter press (for example, a vertical filter press made by Larox Corporation). Preferably, the entire washing water should be reserved in an appropriate vessel so as to be ready to be analyzed. This washing and filtration process is simpler than repulping. The vertical filter press can suppress cracking.

The concentration of As ion remaining in the scorodite immediately after the synthesis varies between synthetic lots, and the water content of the scorodite cake after solid-liquid separation also varies due to a difference in particle size of the scorodite. Thus, the number of washing steps and the volume of washing water required for preparation of scorodite having desirable elution characteristics varies every lot. A constant number of washing steps or a constant volume of washing water may cause insufficient or excess washing effect, resulting in a variation in quality of scorodite. Furthermore, the elution test of the scorodite requires 6-hour shaking, the detection of the end point of washing by the elution test of the scorodite for each washing takes a lot of time and trouble and has no practical use.

The present invention utilizes a relationship that the concentration of the eluted metal ion such as arsenic in the elution test of the scorodite decreases as the concentration of each component of the post-reaction solution contained in the washing water decreases. That is, the elution characteristics of the scorodite are controlled by monitoring the concentration of the component in the post-reaction solution, for example, at least one selected from As, Cu, Fe, and S in the washing water.

A high concentration of each component of the post-reaction solution contained in the washing water shows a low correlation with the eluted As value by the elution test of the scorodite. As the concentration of the component of the post-reaction solution decreases, the correlation with the eluted arsenic value by the scorodite elution test (according to Notification No. 13 by the Environment Ministry) gradually increases. The eluted arsenic value by the elution test of the scorodite can be more precisely estimated from the concentration of each component of the post-reaction solution contained in the washing water. For example, in case where one washing step is carried out at the ratio of 100 to 300 grams more typically 150 to 250 grams (dry weight) of scorodite to 1 L of water, when the As ion concentration decreases to about 1 mg/L in the washing water, the eluted As value by the elution test of the scorodite becomes about 1/10 to 10 times. When the As ion concentration decreases to 0.1 mg/L or less in the washing water, the eluted As value by the elution test of the scorodite becomes ⅓ to 3 times, typically ½ to 2 times.

Accordingly, analysis of the arsenic concentration in the washing water enables the eluted value to be estimated, without an elution test of the scorodite. Since one washing operation takes only 10 minutes, the elution characteristics of the scorodite can be readily estimated. When the target eluted As value is 0.3 mg/L or less, which is a standard value for As elution in domestic repository sites, in the elution test of the scorodite, the target As ion concentration in the washing water is set to 0.1 mg/L or less, preferably 0.05 mg/L in order to obtain scorodite that meets the standard with high probability.

The eluted As value by the elution test of the scorodite can also be estimated from a change in the concentration of other components contained in the post-reaction solution. At a constant ratio of the dry weight of the scorodite to the volume of washing water, the As concentration remaining in the washing water can be estimated from a plot of the correlation between the As concentration contained in the washing water and the concentration of any component other than As in the post-reaction solution. This estimation of the As concentration leads to estimation of the eluted As value by the scorodite elution test, as described above. Accordingly, a target concentration can be set for any component remaining in the washing water.

The As ion concentration in the washing water generally varies at a low concentration within 1 to 0.01 mg/L. This requires an advanced analytical instrument such as ICP for arsenic determination. Furthermore, it is difficult to analyze low-concentration arsenic exhibiting low emission intensity due to low sensitivity. Therefore, monitoring other components in the post-reaction solution of present at a higher concentration in the washing water may facilitate quantitative analysis.

For example, in case where a sulfuric acid leaching solution of electrolytically precipitated copper as an acidic aqueous solution is used, a high concentration of Cu ion is contained in the post-reaction scorodite solution, which can be monitored. The Cu ion concentration in the washing water generally varies within the range of 100 to 1 mg/L, which is higher than the arsenic concentration. Furthermore, copper, which exhibits higher sensitivity than arsenic in ICP, can be more readily analyzed.

In addition, it is known that the copper concentration within this range can be visually observed by calorimetric analysis (semiquantitative analysis) using copper ammonium complex. The colorimetric analysis can semiquantitatively determine the copper concentration by comparison of the intensity of blue color that is developed by addition of aqueous ammonia into a diluted copper solution with that of a standard sample. According to this analytical approach, the end point of washing of the scorodite can be readily determined without use of an advanced analytical instrument such as ICP.

When the Cu ion concentration decreases on the order of n digits, the As concentration also decreases on the order of approximately n digits (within the range of n−1 digits to n+1 digits) If the Cu ion concentration and As ion concentration contained in the washing water are known at a certain point, for example, if the As ion concentration is 1 mg/L and the Cu ion concentration is 200 mg/L in the washing water at a certain point, a decrease in Cu ion concentration to 2 mg/L corresponds to a decrease in As ion concentration to approximately 0.1 to 0.01 mg/L. In case where one washing step is carried out at the ratio of 100 to 300 grams, more typically 150 to 250 grams (dry weight) of scorodite to 1 L of water, when the As ion concentration decreases to about 0.1 mg/L in the washing water, the eluted As value by the elution test of the scorodite can be estimated to be about ⅓ to 3 times, typically about ½ to 2 times. In this case, therefore, from the decrease of the Cu ion concentration in the washing water to 2 mg/L, the eluted As value by the scorodite elution test can be estimated to be 0.3 mg/L or less.

Accordingly, in the case of use of a sulfuric acid leaching solution of electrolytically precipitated copper as an acidic aqueous solution, which is a raw material for scorodite, the variation of the As ion concentration can be estimated from the variation of the Cu ion concentration in the washing water according to the following general procedure. The Cu ion concentration and the As ion concentration contained in the washing water are determined after n (n≧1) cycles, typically one cycle of step (3), a target Cu ion concentration is determined in response to these results, and step (3) is repeated until the Cu ion concentration contained in the washing water used for washing the scorodite decreases to the target concentration or less.

In production of scorodite under the suitable conditions described above, the As ion concentration in the post-reaction solution ranges from 0.1 to 3 g/L, more typically 0.3 to 1 g/L, the Cu ion concentration ranges from 10 to 60 g/L, more typically 20 to 40 g/L. Under such conditions, in case where one washing step is carried out at the ratio of 100 to 300 grams more typically 150 to 250 grams (dry weight) of scorodite to 1 L of water, experience shows that the copper concentration in the washing water is 10 mg/L or less, preferably 5 m/L less in order to suppress the concentration of arsenic eluted from the scorodite to 0.3 mg/L or less. When the arsenic/copper ratio in the post-reaction solution is significantly different from this, the target Cu ion concentration should be reset.

If copper is not contained as a major component in the washing water after washing the scorodite, the end point of washing of the scorodite can be determined from the variation of the concentrations of other major components, for example, iron, or sulfur (in the form of sulfate ion) in the washing water.

In summary, the point of step (3) is to correlate the concentration of each component of the post-reaction solution contained in the washing water used in washing of the scorodite with the arsenic elution properties of the scorodite. Monitoring the concentration of any eluted component in the washing water enables the arsenic elution properties of the scorodite to be indirectly estimated and the end point of washing to be readily determined. That is, washing of scorodite can be finished when the concentration of at least one component of the post-reaction solution contained in the washing water decreases to a predetermined value.

When a sulfuric acid leaching solution of electrolytically precipitated copper is used as an acidic aqueous solution in Step (1), preferred components of the post-reaction solution contained in the washing water for monitoring are Cu, S, Fe, and As ions, and more preferred is Cu ion.

### Sulfuric Acid Leaching Solution of Electrolytically Precipitated Copper

The sulfuric acid leaching solution of electrolytically precipitated copper suitable for a raw material of the scorodite can be prepared, for example, as follows.

First, electrolytically precipitated copper is optionally washed with water. In the washing treatment, the electrolytically precipitated copper is repulped with water and agitated for 0.5 to 6 hours to dissolve the electrolytic solution (containing copper sulfate, Ni, and Fe) remaining on the electrolytically precipitated copper and slight amounts of Ni and Fe contained in the electrolytically precipitated copper, and the slurry is filtered for solid-liquid separation. During this step, most of Fe and Ni can be separated from the electrolytically precipitated copper.

However, the main purpose of this step is to determine the zero-valent (water-insoluble) copper (excluding cupper sulfate) in the total copper content of the electrolytically precipitated copper, in order to more precisely determine the amount of sulfuric acid required for sulfuric acid leaching of the electrolytically precipitated copper in the subsequent step. When trace amounts of Ni and Fe are negligible, when the copper sulfate content is known, or only a small amount of electrolyte solution is brought into the electrolytically precipitated copper, this step is unnecessary.

After optional washing treatment, oxygen-containing gas is introduced into the electrolytically precipitated copper acidified with sulfuric acid, while the solution is agitated at a temperature and for a time that are sufficient to oxidize As components contained in the electrolytically precipitated copper to pentavalent As, which is leached into the sulfuric acid solution. The solution is then separated into the leaching residue containing Sb and Bi components and the sulfuric acid leaching solution containing the pentavalent As component by solid-liquid separation.

In general, Cu is oxidized to Cu²⁺ and As to As⁵⁺ according to the following leaching reaction:

Cu+H₂SO₄+1/2O₂→CuSO₄+H₂O (1)

2As+5/2O₂+3H₂O→2 H₃AsO₄ (2)

The amount of the sulfuric acid to be used is preferably in the range of 1.0 to 1.2 equivalents on the basis of the Cu content. At an amount less than 1.0 equivalent, the leaching solution is weekly acidic, which causes precipitation of Cu₃AsO₄, resulting in a lower leaching rate of Cu and As. At an amount exceeding 1.2 equivalents, the amount of sulfuric acid to be used is large, although the leaching rate of Cu and As is not affected. Though the concentrations of Cu and As in the sulfuric acid solution are not limited, since concentrations exceeding their solubilities cause a reduction in leaching rate of Cu and As, concentrations below the solubilities of Cu²⁺ and As⁵⁺ are preferred.

The pH suitable for formation of crystalline scorodite, which is synthesized in the subsequent step, ranges from 1.0 to 1.5. However, a lower sulfuric acid concentration tends to decrease the sulfuric acid leaching rate, in other words, the recovery rates of copper and arsenic. Thus, the sulfuric acid concentration used in leaching is preferably controlled such that the pH is less than 1. Even in the case of a pH of the sulfuric acid leaching solution of 1 or more, trivalent iron is preferably added in the form of acidic aqueous solution for synthesis of scorodite. For example, the pH of an aqueous ferric sulfate solution and an aqueous polyferric sulfate solution is approximately 0.6.

In the sulfuric acid leaching, the solution is agitated, for example, at 70 to 95° C. for 4.5 to 11 hours, preferably 80 to 95° C. for 7 to 11 hours to form pentavalent arsenic by oxidation. Since the sulfuric acid leaching is exothermic reaction, the reaction can proceed without external heating. The agitation time may be prolonged and can be determined on the basis of economic principle.

In order to facilitate oxidation of As, a sufficient volume of oxygen-containing gas (for example, 10 equivalents of oxygen to copper/7 hours) in the form of microbubbles are preferably supplied. Vigorous agitation is preferred. For example, introduction and/or agitation of oxygen-containing gas should preferably be performed by jet-spraying. The exemplary value is determined in the case of a jet-spraying device (“JET AJITER”: trade name). The reaction rate with an agitator using common blades is lower, two or more times of reaction time is required even if 3.5 or more times oxygen-containing gas is introduced. Valency control of arsenic in this stage facilitates formation of scorodite in a subsequent step. Cu²⁺ also promotes oxidation of arsenic.

Any oxygen-containing gas that does not adversely affect the reaction can be used without restriction. Examples of such gas include pure oxygen and mixtures of oxygen and inert gases. Air is preferred because of ease of handling and material costs.

The resulting sulfuric acid leaching solution of electrolytically precipitated copper is mixed with trivalent iron to prepare an acidic aqueous solution containing pentavalent As and trivalent Fe. In this case, examples of trivalent iron include iron oxide, iron sulfate, iron chloride, and iron hydroxide. Preferably, trivalent iron should be supplied in the form of acidic aqueous solution in view of a reaction in an aqueous solution. Since it is most effective that the post-deironing solution is recycled to the electrolytic solution for electro refining, use of an aqueous ferric sulfate (Fe₂(SO₄)₃) solution is preferred. An aqueous polyferric sulfate solution, which is used in liquid waste treatment, can also be used.

In terms of removal of arsenic, the amount of trivalent iron used is at least 1.0 equivalent and preferably 1.1 to 1.5 equivalents on the basis of the amount of arsenic, in economical view.

### EXAMPLES

Examples described below are to be considered illustrative for better understanding of the present invention and its advantages, and not restrictive.

### Example 1

### Production of Sulfuric Acid Leaching Solution of Electrolytically Precipitated Copper

To 418 grams (dry weight) of electrolytically precipitated copper, 259 grams of 98% conc. sulfuric acid (1 equivalent for copper contained in electrolytically precipitated copper) was added, then water was added into a 1.85 L of slurry (slurry concentration: 256 g/L). While air was introduced at a rate of 4 L/min, the solution was agitated for 7 hours for leaching. Since microbubbling of introduced air facilitates the leaching reaction, air was introduced and agitated with a JET AJITER (made by SHIMAZAKI). The liquid temperature was controlled at 80° C. in a water bath. The copper concentration at the end of leaching was about 90 g/L, which exceeded the solubility, about 50 g/L, at room temperature. In order to prevent deposition of copper(II) sulfate, pentahydrate, solution was diluted with water into 3.5 L. The solution was separated into filtrate (sulfuric acid leaching solution) and the residue by suction filtration using a Buchner funnel. Table 1 shows the physical quantities of the resulting sulfuric acid leaching solution and the residue.

This operation was repeated twice, and these two batches of filtrate were mixed together. The mixed solution was used for synthesis of crystalline scorodite in the next stage.

TABLE 1

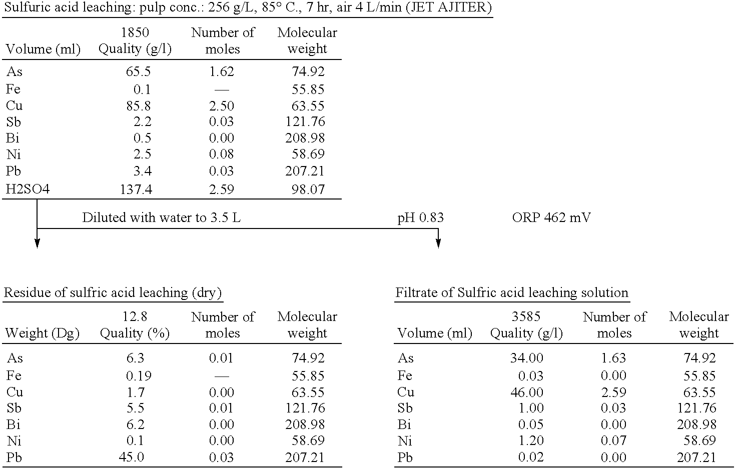

### Synthesis of Scorodite Crystal

To 6.95 L of sulfuric acid leaching solution (pH: 0.86) of the electrolytically precipitated copper, 1.112 L of polyferric sulfate (hereinafter referred to as “polyiron”) made by Nittetsu Mining CO., Ltd. was added. The pH varied to 0.59. The solution was heated at 95° C. for 24 hours to synthesize scorodite while the volume of the solution was maintained at 8.1 L by addition of water. After the reaction, crystalline scorodite was separated with a Buchner funnel by spontaneous filtration, with prevention of cracking. Table 2 shows the physical quantities of the crystalline scorodite and the filtrate solution.

Another batch of scorodite was synthesized under the same conditions in order to determine the eluted arsenic value from the scorodite when the scorodite was separated from the post-reaction solution. The results of the elution test according to Notification No. 13 by the Environment Ministry were 7 mg/L for elution of arsenic and 1200 mg/L for elution of copper (see Table 3).

TABLE 2

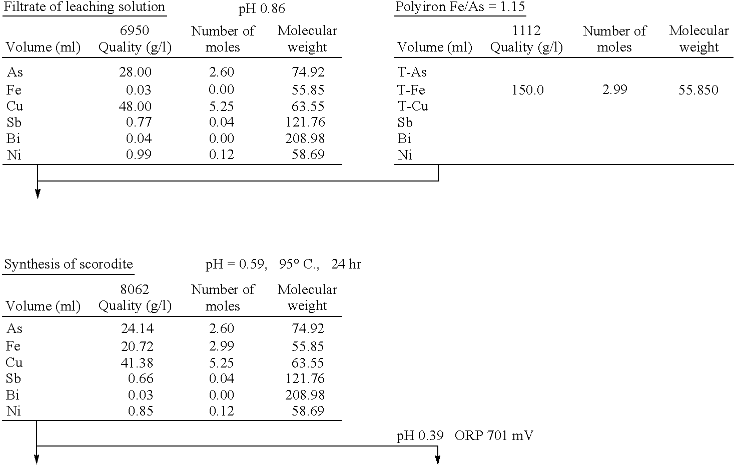

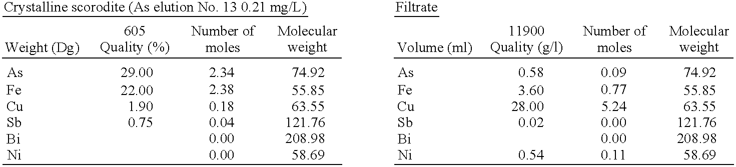

### <Washing of Scorodite>

The scorodite cake (wet weight: 756.5 grams, corresponding to 605 grams dry weight) on the Buchner funnel was washed with 500 mL of water six times (3 L in total) by spontaneous filtration (gravimetric filtration). The water was continuously fed during filtration such that the crystalline scorodite was always immersed in the washing water to prevent cracking of the cake, as described above and to maintain satisfactory washing effect. Eventually, blue color of copper ion disappeared from the washing water, and clear and colorless of the solution was confirmed (in conventional processes, it was believed that washing was completed). Using part of the scorodite, the elution test according to Notification No. 13 by the Environment Ministry was carried out. The elution of arsenic was 0.21 mg/L and the elution of copper was 170 mg/L (see Table 3). Then, 338.4 grams of scorodite was batched off from the Buchner funnel, placed into a 3 L beaker, and repulped and agitated with 2 L of water for 10 minutes. The dispersion was suction-filtrated to separate the scorodite by solid-liquid separation.

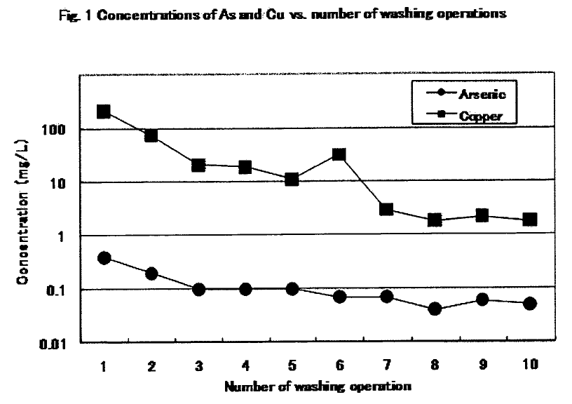

This repulping, agitation, and solid-liquid separation cycle was repeated ten times, and the concentrations of arsenic and copper remaining in the filtrate (washing water) were determined by ICP analysis. Table 4 and FIG. 1 show the analytical results. Using this scorodite after ten washing operations, the elution test (Notification No. 13 by the Environment Ministry) was carried out. The elution of arsenic was 0.05 mg/L, and copper was 6.6 mg/L (see Table 3).

TABLE 3
Results of test of scorodite before and after washing
according to Notification No. 13 by the Environment Ministry

| | | Copper |
|---|---|---|
| | Arsenic concentration | Concentration |
| | (mg/L) | (mg/L) |
| Before washing | 7.0 | 1200 |
| When washing solution becomes | 0.21 | 170 |
| colorless | | |
| After washing | 0.05 | 6.6 |

TABLE 4
Arsenic and copper concentrations in washing solution after
preliminary washing operation with 3 L water

| | Arsenic concentration | Copper concentration |
|---|---|---|
| Washing operation | (mg/L) | (mg/L) |
| 1st | 0.4 | 220 |
| 2nd | 0.2 | 75 |
| 3rd | 0.1 | 21 |
| 4th | 0.1 | 19 |
| 5th | 0.1 | 11 |
| 6th | 0.07 | 32 |
| 7th | 0.07 | 2.9 |
| 8th | 0.04 | 1.8 |
| 9th | 0.06 | 2.2 |
| 10th | 0.05 | 1.8 |

### Example 2

### Preparation of Sulfuric Acid Leaching Solution of Electrolytically Precipitated Copper

To 742 grams (dry weight) of electrolytically precipitated copper, 702 grams (1.1 equivalents on the basis of copper contained in the electrolytically precipitated copper) of 98% conc. sulfuric acid was added. Furthermore, water was added into 2.7 L (pulp concentration: 274 g/L) of slurry. Air was fed at a rate of 5 L/min with agitation for hours for leaching. Since fine air bubbles were effective for high reaction efficiency, a JET AJITER (made by SHIMAZAKI) was used for feeding and agitation of air. The liquid temperature was controlled at 80° C. in a water bath. The copper concentration after leaching was about 150 g/L, which was higher than the solubility at room temperature, 50 g/L. The solution was diluted with water into 8 L to prevent deposition of copper(II) sulfate pentahydrate. The solution was separated into the filtrate (sulfuric acid leaching solution) and the residue by solid-liquid separation with a filter. Table 5 shows the physical quantities of the sulfuric acid leaching solution and the residue. The filtrate was used for synthesis of crystalline scorodite in the subsequent step.

TABLE 5

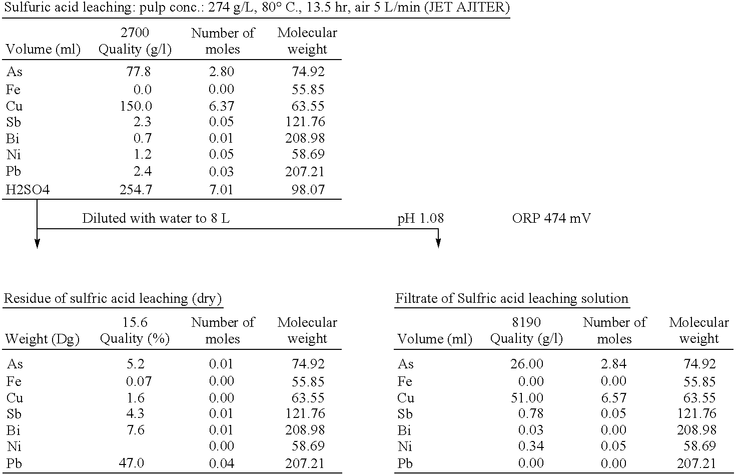

### Synthesis and Washing of Crystalline Scorodite

To 8.08 L of the resulting sulfuric acid leaching solution (pH=1.02) of electrolytically precipitated copper, 1.15 L of polyferric sulfate (hereinafter, referred to as polyiron) made by Nittetsu Mining CO., Ltd. was added. The pH varied to 0.74. The solution was heated at 95° C. for 24 hours to synthesize scorodite while the volume of the solution was maintained at 9.3 L by addition of water. Although the reaction did not proceed immediately after mixing of the sulfuric acid leaching solution with the polyferric sulfate solution at room temperature, the formation of crystalline scorodite was observed at 85° C. during the heating step. After the reaction, crystalline scorodite was separated with a Buchner funnel by suction filtration. Table 6 shows the physical quantities of the crystalline scorodite and the filtrate solution.

TABLE 6

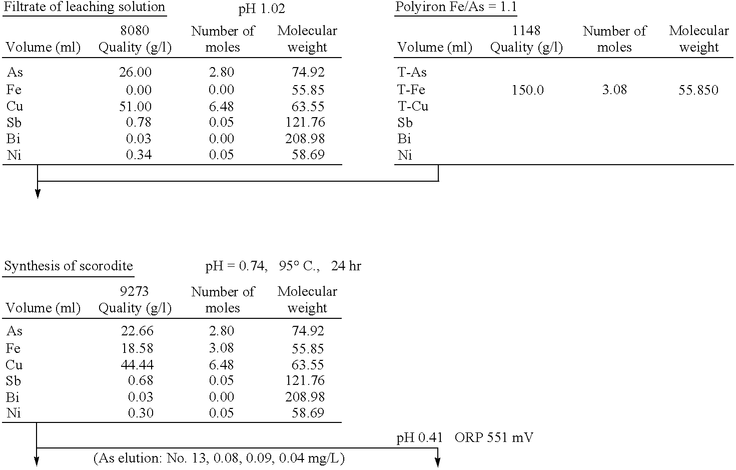

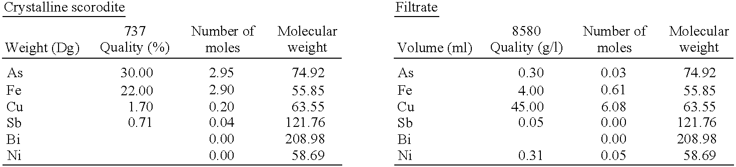

The crystalline scorodite was repulped with water into a pulp concentration of about 200 to 250 g/L. After agitation for 10 minutes, the pulp was separated into the scorodite and the washing solution by filtration. This operation was repeated four times. The filtration was gravimetric filtration that prevents cracking as in Example 1. Each washing solution was subjected to colorimetric analysis using copper ammonium complex according to the following procedure. To a 100-mL transparent vial with a cap, about 90 mL of washing water after washing the scorodite was placed, and about 10 mL of 25% aqueous ammonia (reagent grade) was added. The mixture was agitated to promote coloring by formation of a copper ammonium complex. Standard solutions having known copper concentrations (for example, 50, 20, 10, 5, 1, and 0 mg/L) were also subjected to coloring by formation of copper ammonium complex. The copper concentration of the sample was quantitatively or semiquantitatively determined by comparison with coloring of the standard solutions.

The first washing water was not subjected to determination because the blue of the solution suggested a copper concentration significantly exceeding 50 mg/L. The concentration was 30 mg/L for the second water, 7 mg/L for the third water, and 7 mg/L for the fourth water. After the washing step, the elution test of arsenic from the scorodite was carried out three times. The eluted values were 0.09, 0.08, and 0.04 mg/L, respectively. This shows slight and steady elution.

A series of operations including leaching of the electrolytically precipitated copper, synthesis of the scorodite, and washing of the scorodite were carried out eight times in total under the same conditions. The end point of the washing was determined at a copper concentration of 10 mg/L or less (by copper ammonium complex) in the washing water. The number of the washing operations when the copper concentration in the washing water was 10 mg/L or less varied from 4 to 7 among the batches. The eluted values of each batch are shown on the right column in Table 7. The eluted arsenic value was 0.05 mg/L on average and 0.03 mg/L on standard deviation. This shows stable elution.

TABLE 7
Effect of washing determination

| Washing on funnel | | | Determination after washing | | |
|---|---|---|---|---|---|
| (Until colorless) | | | (Cu < 10 mg/L) | | |
| | Eluted arsenic value* | | | Eluted arsenic value* | |
| Run No. | (mg/L) | | Run No. | (mg/L) | |
| No. 104 | 0.3 | | No. 152 | 0.04, 0.06 | |
| No. 105 | 0.1 | | | 0.04, 0.06 | |
| No. 106 | 0.1 | | No. 153 | 0.03, 0.02 | |
| No. 108 | 0.2 | | No. 158 | 0.04, 0.01 | |
| No. 109 | 1.2, 0.3 | | | 0.02, 0.02 | |
| No. 110 | 0.4, 0.2 | | No. 160 | 0.03, 0.06 | |
| No. 111 | 0.4 | | No. 161 | 0.03, 0.12 | |
| No. 116 | 0.2 | | | 0.04, 0.07 | |
| No. 115 | 0.4, 0.1 | | No. 165 | 0.05, 0.12 | |
| | 0.7 | | | 0.02, 0.07 | |
| No. 117 | 0.1, 0.1 | | No. 166 | 0.03, 0.08 | |
| No. 118 | 0.1, 0.1 | | | 0.02, 0.06 | |
| No. 119 | 1.6, 0.8 | | No. 168 | 0.09, 0.08 | |
| No. 121 | 0.2, 0.5 | | | 0.04 | |
| | Average | SD** | | Average | SD** |
| | 0.4 | 0.40 | | 0.05 | 0.03 |

*According to Notification No. 13 by the Environmental Ministry
**Standard deviation

### Example 3

Scorodite (3.14 kg of wet weight, corresponding to kg of dry weight) synthesized as in Example 2 was filtered through a vertical filter press (type PF 0.1) made by Larox Corporation, and the residue was compressed to obtain scorodite cake. The cake in the chamber of the filter press was washed with 8 L of water and compressed. This operation was repeated four times. Each washing solution was subjected to determination of the copper concentration by calorimetric analysis as in Example 2. The first washing solution was not subjected to determination. The copper concentrations of second, third, and fourth washing solutions were 50, 10, and 1 mg/L, respectively. After these washing operations, the eluted arsenic value was 0.06 mg/L. The results show that the filter press is also effective for determination of the end point of washing by copper.

### Comparative Example 1

### Sulfuric Acid Leaching of Electrolytically Precipitated Copper

A sulfuric acid leaching solution was prepared from electrolytically precipitated copper as in Example 1, as a raw material for synthesis of crystalline scorodite in the following step.

### Synthesis and Washing of Crystalline Scorodite

To 1.24 L of sulfuric acid leaching solution (pH=1.03) of electrolytically precipitated copper, 0.265 L of polyferric sulfate (hereinafter referred to as polyiron) made by Nittetsu Mining CO., Ltd was added. The pH varied to 0.61. The solution was heated at 95° C. for 24 hours to synthesize scorodite while the volume of the solution was maintained at 1.5 L by addition of water. After the reaction, crystalline scorodite was separated with a Buchner funnel by spontaneous filtration, with prevention of cracking. Table 8 shows the physical quantities of the crystalline scorodite and the filtrate solution.

TABLE 8

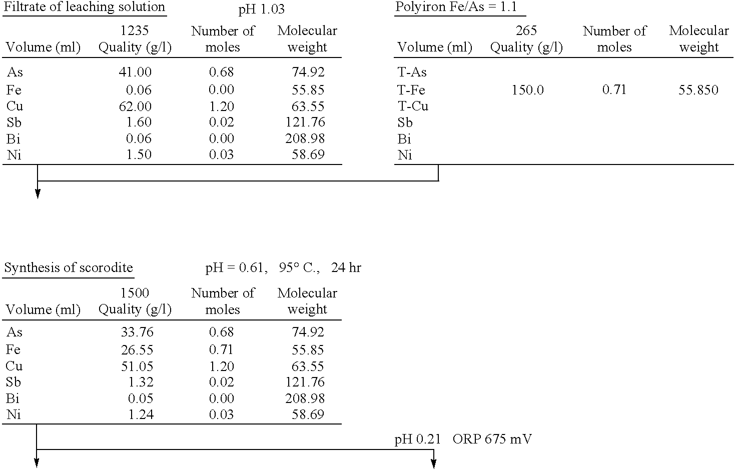

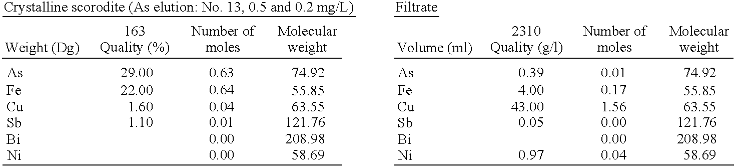

The scorodite cake (wet weight: 220.9 grams, corresponding to 163 grams dry weight) on the Buchner funnel was washed with 160 mL of water five times (0.8 L in total) by spontaneous filtration (gravimetric filtration), as in Example 1 to prevent cracking. After the synthesis, it was confirmed that blue color of copper ion disappeared from the washing water, and clear and colorless of the solution was confirmed. Using the scorodite, the elution test of arsenic was carried out twice according to Notification No. 13 by the Environment Ministry. The eluted arsenic values were 0.2 and 0.5 mg/L, respectively.

A series of operations including leaching of the electrolytically precipitated copper, synthesis of the scorodite, and washing of the scorodite were carried out 13 times in total under the same conditions. After each batch, it was confirmed that blue color of copper ion disappeared from the washing water, and clear and colorless of the solution was confirmed. Each eluted value is shown on the left column in Table 7. The eluted arsenic value was 0.4 mg/L on average and 0.4 mg/L on standard deviation. This shows noticeable and unstable elution.

What is claimed is:

1. A method of making scorodite comprising the steps of:
(1) heating an acidic aqueous solution containing pentavalent As and trivalent Fe at a temperature and for a time that are effective for synthesis of crystalline scorodite;
(2) separating the synthesized scorodite from the post-reaction solution by solid-liquid separation; and
(3) washing the scorodite with water and separating the scorodite from the washing solution by solid-liquid separation;
wherein step (3) is repeated until the concentration of at least one component of the post-reaction solution contained in the washing solution used for washing the scorodite decreases to a predetermined level.

2. The method according to claim 1, wherein step (3) is repeated until the concentration of As ion contained in the washing solution used for washing the scorodite decreases to a predetermined level.

3. The method according to claim 2, wherein step (3) is repeated until the concentration of As ion contained in the washing solution used for washing the scorodite decreases to 0.3 mg/L or less.

4. The method according to claim 1, wherein the acidic aqueous solution in step (1) is a sulfuric acid leaching solution of electrolytically precipitated copper, and step (3) is repeated until the concentration of at least one component of the post-reaction solution selected from the group consisting of Cu, S, Fe, and As contained in the washing solution used for washing the scorodite decreases to a predetermined level.

5. The method according to claim 1, wherein the acidic aqueous solution in step (1) is a sulfuric acid leaching solution of electrolytically precipitated copper, and step (3) is repeated until the concentration of Cu ion contained in the washing solution used for washing the scorodite decreases to a predetermined level.

6. The method according to claim 5, wherein the acidic aqueous solution in step (1) is a sulfuric acid leaching solution of electrolytically precipitated copper, the concentrations of Cu ion and As ion contained in the washing solution used for washing the scorodite after n-th (n≧1) step (3) are measured, a target concentration of the Cu ion is determined in response to the measured concentrations, and step (3) is repeated until the concentration of the Cu ion contained in the washing solution used for washing scorodite decreases to the target concentration.

7. The method according to claim 5, wherein the acidic aqueous solution in step (1) is a sulfuric acid leaching solution of electrolytically precipitated copper, the concentration of As ion is in the range of 0.1 to 3 g/L and the concentration of Cu ion is in the range of 10 to 60 g/L in the post-reaction solution, and 100 to 300 g (dry weight) of scorodite is washed with 1 L of water in each step (3), and step (3) is repeated until the concentration of the Cu ion contained in the washing solution used for washing scorodite decreases to 10 mg/L or less.

8. The method according to claim 5, wherein whether the concentration of the Cu ion contained in the washing solution used for washing scorodite decreases to the predetermined level is determined by colorimetric analysis.

9. The method according to claim 1, wherein the washing in step (3) is performed by addition of water to the scorodite followed by repulping and agitation.

10. The method according to claim 1, wherein in step (2), the solid-liquid separation is spontaneous filtration using a funnel, and in step (3), the water is poured on the scorodite remaining on the funnel such that the entire scorodite is covered by the water wherein the solid-liquid separation is gravimetric or suction filtration.

11. The method according to claim 1, wherein in step (3), the scorodite is disposed in a vertical filter press, the water is supplied to the filter press, and then the scorodite is compressed.

12. A method of washing scorodite comprising an operation of separating the scorodite from washing water by solid-liquid separation, wherein the concentration of at least one component of the post-reaction solution eluted from the scorodite contained in the washing solution used in the washing is measured, and whether the operation is repeated is determined in response to the measured concentration.
